(19) United States
(12) Patent Application Publication
(10) Pub. No.: US 2014/0157983 A1
(43) Pub. Date: Jun. 12, 2014

(54) Device and Method for Degassing of Liquids

(71) Applicant: STRATEC Biomedical AG, Birkenfeld (DE)

(72) Inventors: Martin Trump, Birkenfeld (DE); Volker Barenthin, Birkenfeld (DE)

(21) Appl. No.: 14/103,400

(22) Filed: Dec. 11, 2013

(30) Foreign Application Priority Data
Dec. 11, 2012 (GB) 1222249.3

(51) Int. Cl. B01D 19/00

(52) U.S. Cl. CPC B01D 19/0031
USPC 95/46; 96/6

(57) ABSTRACT

A modular degassing device (40) is disclosed. The modular degassing device (40) comprises outer clamping plates (330, 340) with at least one degassing module (200) arranged therebetween, wherein the degassing module (200) comprises two modular plates (310, 320) adjacently arranged, both modular plates (310, 320) having a first channel on sides facing a membrane (46) placed therebetween, wherein the first channel of one modular plate (310, 320) is a fluid channel (224) on one side of the membrane (46), and the first channel of the other modular plate (310, 320) is a vacuum channel (212) on the other side of the membrane (46).

### BACKGROUND

1. Field of the Invention

Devices and methods for degassing liquid media in diagnostic systems are disclosed. For example, devices and methods for removing free and dissolved gas mixtures, such as air, from fluid media, such as water, to be used in diagnostic systems are disclosed. The devices and methods can utilize vacuum-dependent removal of gasses from the fluids in the diagnostic systems. The device can be constructed a modular device.

2. Description of the Related Art

Gasses are typically contained in fluids, for example in water. The gasses are usually present in a free or undissolved phase, i.e. as minuscule gas bubbles, and also in a dissolved state in the fluid. The concentration of these dissolved gasses depends on a number of factors, such as the ambient pressure, the temperature or the salinity. In analytical and diagnostic systems specific process steps involving a change in pressure or temperature can cause gasses to dissolve in or evaporate from the fluid. The gases can form gas bubbles which, depending on the application, can be at the origin of process disruptions.

As a result of temperature differences, gas bubbles can already be generated in storage containers. The inlet side of a vacuum pump can create a local vacuum causing a pressure imbalance leading to a liberation of the gasses from the fluid. The design of the vacuum pump can also generate pressure differences. Due to their high oscillating frequency, membrane pumps generate high local negative and positive pressures facilitating the formation of gas bubbles carried away by the fluid.

Throughout the entire fluid line system, line diameters can be changed by fittings and manifolds. Like in a Venturi tube, the pressure of the fluid rises before a constriction, causing the fluid to increase its gas absorption capacity. Once the fluid reaches the constriction, the pressure drops and the excess gas concentration dissolves, generating gas bubbles.

Also, due to the roughness of the inner tubing walls, evaporated, minuscule gas bubbles can be deposited on tubing walls in the fluid system. Clustering together, the gas bubbles can create larger bubbles that are eventually carried downstream by the liquid.

Also, as a result of pump-related negative pressures, pipetting systems used for fluid analysis and diagnoses are prone to pressure differences leading to the formation of the gas bubbles.

Degassing is performed to remove these gasses from fluids. Degassing can be performed for a variety of applications including preparing the fluids for laboratory analysis, such as those mentioned above and more specifically for liquid chromatography, preparing beverages such as potable water, and purifying industrial fluids, such as oils or resins.

Degassing can currently be performed by a number of methods. Fluids can be degassed by spraying them into a chamber of a sealed, vacuum tank to atomize the fluids and increase the surface area onto which the vacuum will be able to remove the gas. This method is inefficient, requires large tanks, and is limited in its flow rate due to the tank size. This method proves to be not reasonably compact enough for many settings due to the flow rates needed.

Fluids can also be degassed by heating the fluid to release the gas. This thermal degassing method is obviously not possible for fluids for which heating damages or alters critical characteristics of the fluids. The fluids can also be degassed with chemical additives or the addition of stripping gasses. However, the addition of chemicals and stripping gasses may contaminate the fluids, and the latter method will still leave the stripping gas in the fluid. Heating and contaminating methods are poor degassing choices for those fluids for which the integrity of the fluid characteristics is critical.

Fluids can also be degassed by applying a force, such as in a centrifuge, to the fluid to separate the gasses based on density differences of the gasses. This method can only be applied on fluids with a sufficiently high viscosity, such as some oils or resins, and is not useful for fluids with insufficient viscosities.

Fluids can also be degassed by the application of ultrasonic waves to cause cavitation bubbles. Dissolved and free gasses will accumulate in the cavitation bubbles. Once the cavitation bubbles reach a critical size, the cavitation bubbles will rise in the fluid and can be removed. This method is better suited to remove free gasses (i.e., gas bubbles, rather than dissolved gasses), and is the most expensive method due to the ultrasonic components required.

Other common methods for degassing the fluids employ degassing through membranes that allow gas flow but restrict liquid flow. The fluid can be on one side of the membrane and a vacuum can be applied to the other side of the membrane to draw the gasses out of the fluid through the membrane. The membrane-based methods include the use of hollow fiber membranes and membrane tubes. Hollow fiber membranes restrict the flow rate. Maximum flow rates up to about 10 ml/min are typical for high performance liquid chromatography (HPLC) applications using hollow fiber degassing. In order to increase the flow rate, the systems would have to be scaled-up, using more hollow fibers. There are also contactor-type hollow fiber degassers that can reach a flow rate of about 600 ml/minute, but the contactor-type hollow fiber degassers are complex and expensive.

Accordingly, degassing devices and methods are desired that will allow for high flow-rates without contaminating or heating the fluids. Devices and methods for degassing are also desired that will be scalable without extreme expense or space requirements. Also desired are devices and methods that will be able to degas fluids regardless of the fluid viscosity. Devices and methods are also desired that will be able to degas both free and dissolved gasses from fluids.

### SUMMARY OF THE INVENTION

A modularised degassing device and method for degassing a fluid are disclosed that apply vacuum on the fluid (e.g., water) to change the ambient pressure to change the concentration of dissolved gasses.

A modular degassing device is disclosed. The modular degassing device comprises outer clamping plates with at least one degassing module arranged therebetween, wherein the degassing module comprises two modular plates adjacently arranged, both modular plates having a first channel on sides facing a membrane placed therebetween, wherein the first channel of one modular plate is a fluid channel on one side of the membrane, and the first channel of the other modular plate is a vacuum channel on the other side of the membrane.

Any two degassing modules adjacently arranged may both have a second channel on sides facing a membrane placed between the two degassing modules, wherein the second channel of one degassing unit is a fluid channel on one side of the membrane, and the second channel of the other degassing unit is a vacuum channel on the other side of the membrane.

The two modular plates of any one of the at least one degassing unit have an intermediate modular plate arranged therebetween, the intermediate modular plate having on both sides a third channel facing a membrane placed between the intermediate plate and the respective one of the two modular plates, wherein one third channel is a fluid channel facing a vacuum channel of one of the two modular plates, and the other third channel is a vacuum channel facing a fluid channel of the other of the two modular plates.

The membranes may be gas permeable and hydrophobic.

The fluid channels may be fluidly connected in series or in parallel.

The vacuum channels may be fluidly connected in series or in parallel

The modular degassing device may further comprise clamping pins delivering a compressive force between the top clamping plate and the bottom clamping plate.

The clamping pins may be received in clamping pin ports.

A fluid pump may be fluidly connected to the fluid channels.

A vacuum pump may be fluidly connected to the vacuum channels.

A pressure regulator may be in data or power communication with the fluid pump and the vacuum pump.

A method for degassing a fluid is disclosed. The method comprises fluidly separating a plurality of fluid channels and a plurality of vacuum channels by means of a gas permeable and hydrophobic membranes, drawing the fluid to flow along the plurality of fluid channels, supplying a vacuum to the plurality of vacuum channels, drawing gases from the fluid in the plurality of fluid channels through the membranes into the plurality of vacuum channels, withdrawing the gasses from the plurality of vacuum channels.

Use of a modular degassing device for degassing a liquid is disclosed.

### BRIEF DESCRIPTION OF THE DRAWINGS

FIG. 1 is a schematic figure illustrating a variation of a system for degassing a fluid.

FIGS. 2A and 2B are top and bottom perspective views, respectively, of a variation of the degassing module.

FIG. 2C is an exploded view of a variation of the degassing module of FIGS. 2A and 2B.

FIG. 2D is a bottom view of a variation of the vacuum plate of the degassing module of FIGS. 2A through 2C.

FIG. 2E is a top view of a variation of the fluid plate

FIG. 3 is a partial cut-away view of a variation of the degassing device.

FIGS. 4A and 4B are top perspective and bottom perspective views, respectively, of a variation of the degassing device.

FIGS. 4C and 4D are top perspective and bottom perspective partially exploded views, respectively, of variations of the degassing device.

FIG. 5 is a top perspective view of a variation of the fluid plate.

FIG. 6 is a bottom perspective view of a variation of the vacuum plate.

### DETAILED DESCRIPTION OF THE INVENTION

A modular degassing device and method for degassing a fluid are disclosed that apply vacuum on the fluid (e.g., water) to change the ambient pressure to change the concentration of dissolved gasses. The vacuum can be applied to the fluid to shift the balance between the ambient pressure and the partial pressure of the gasses dissolved in the water to such an extent that the gas concentration in the fluid drops to an acceptable level, (e.g., degassing the fluid).

According to this disclosure, a fluid is to understood as any substance capable of flowing in response to a drawing and/or pressing force. A fluid according to this disclosure can be a liquid of any viscosity or a gas.

Further, according to this disclosure, a channel is to be understood as a guide capable of guiding a fluid flowing along a path. A channel according to this disclosure may be a path recessed within a plate and/or within a membrane covering the plate.

Fluid can be conveyed into the modular degassing device in a parallel and/or serial feed through an inlet. The degassing modules can have a fluid channel forming meandering pattern of the flow path. The meandering fluid channels maximize the water surface area exposed to a negative pressure across a membrane on the fluid channel. The fluid passes through the first modular layer of the modular degassing device and is then transferred to the next modular layer. The meandering pattern of the flow path ensures that each module allows a maximum amount of fluid to be exposed to the vacuum (3) applied. A gas permeable but hydrophobic membrane is used to separate the liquid phase (water) from the gaseous phase (defined vacuum). While fluid is running over it, this membrane acts as a filter permeable only to the desired gas molecules.

The modular degassing device can be modularised in order to reduce cost and to adapt the modular degassing device to a specific application. This concept allows the adaptation to different needs, such as the flow rate. The entire system is designed for in-line line use, a buffer tank is not required. To increase tightness, the modules can be pressure sealed and/or fitted between pressure plates.

The modular degassing device can have a flat first membrane, a first plate and a second plate. The first plate can have a first fluid channel. The first fluid channel can have a first fluid leg, and a second fluid leg extending at a first fluid leg turn angle from the first fluid leg. The second plate can have a first vacuum channel. The first flat membrane can be between the first plate and the second plate. The first fluid channel and the first vacuum channel form first channels of the modular degassing device.

The first vacuum channel can have a first vacuum leg and a second vacuum leg extending at a first vacuum leg turn angle from the first vacuum leg. The first vacuum leg turn angle can be equal to the first fluid leg turn angle. The first fluid leg turn angle can be about 90°, or about 180°.

The first fluid leg and the second fluid leg can be perimeter fluid legs. The modular degassing device can have a third fluid leg. The first fluid leg can be parallel with the second fluid leg. The second fluid leg can be parallel with the third fluid leg.

The modular degassing device can have perimeter fluid legs. The first fluid leg and the second fluid leg can be surrounded on at least two sides by the perimeter fluid legs. The perimeter fluid legs, the first fluid leg, and the second fluid leg can be coplanar with the top surface of the first plate.

The first plate can have a first plate area. The first fluid channel can have a first fluid channel area in the plane of the first plate. The first fluid channel area can be the footprint of the first fluid channel as seen from a perpendicular perspective to the plane of the plate surface. The first fluid channel area can be greater than or equal to 8,000 mm.

The vacuum channel can be on a first side of the second plate. The first side of the second plate can face the first plate. The second plate can have a second fluid channel on a second side of the second plate. The second side of the second plate can face away from the first plate. Likewise, the first plate can have the first fluid channel on a first side and a second vacuum channel on a second side of the first plate. The second side of the first plate can face away from the second plate. The second fluid channel and second vacuum channel form second channels of the modular degassing device.

The flat first membrane can be pressure-sealed to the first plate and the second plate between a first clamping plate and a second clamping plate. The first clamping plate and the second clamping plate form outer clamping plates positioned on two sides of first plate and the second plate.

The modular degassing device can have a flat second membrane. The first membrane can be on a first side of the first plate. The flat second membrane can be on a second side of the first plate. The first side of the first plate can be opposite to the second side of the first plate.

A method for degassing a fluid is disclosed. The method can include pumping the fluid through a modular degassing device. The modular degassing device can have a first degassing module. The first degassing module can have a first gas-transfer surface in a first plane. The pumping can include pumping greater than about 1,500 liters per minute of the fluid.

The modular degassing device can have a second degassing module. The second degassing module can have a second gas-transfer surface in a second plane. The first plane can be parallel with the second plane.

The method can include attaching a second module to the first module before pumping the fluid. Pumping the fluid can include flowing the fluid through the first degassing module, and then flowing the fluid through the second degassing module.

A method of altering a maximum flow rate of a modular degassing device is disclosed. The modular degassing device can have a first degassing module and a compression system. The compression system can be configured to compress the degassing module. The method can include adding a second degassing module to the modular degassing device. Adding the second module can include increasing the maximum flow rate 200%. Adding the second module can include increasing the size of the modular degassing device by less than 100%. The method can also include compressing the first degassing module and the second degassing module with the compression system.

The first degassing module can have a first flat membrane. The second degassing module can include a second flat membrane.

The method can include pumping or urging a fluid through the modular degassing device. The urging of the fluid through the modular degassing device can include urging the fluid through first degassing module. The urging of the fluid through the modular degassing device further comprises urging the fluid through the second degassing module after the fluid exits the first degassing module.

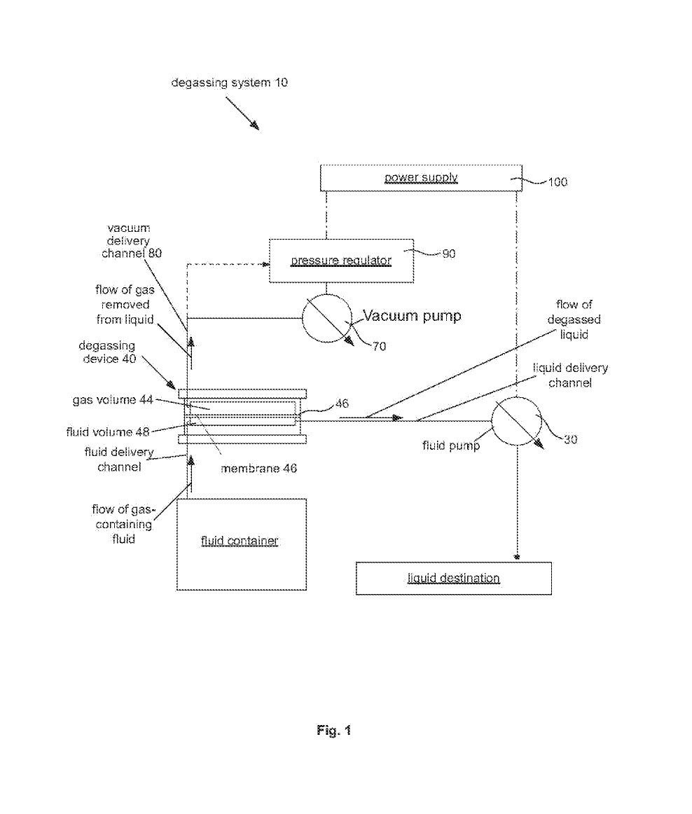

FIG. 1 illustrates a degassing system 10 that can be used to degas, or separate gas from a liquid in a fluid. The gas can be dissolved and/or freed (i.e., undissolved) in the fluid.

The degassing system 10 has a fluid container 20. The fluid container 20 can be a sealed or open reservoir that can hold the fluid containing the liquid and the gas.

The degassing system 10 can have a fluid pump 30. The fluid pump 30 can be in fluid communication with the fluid container 20, for example through a modular degassing device 40.

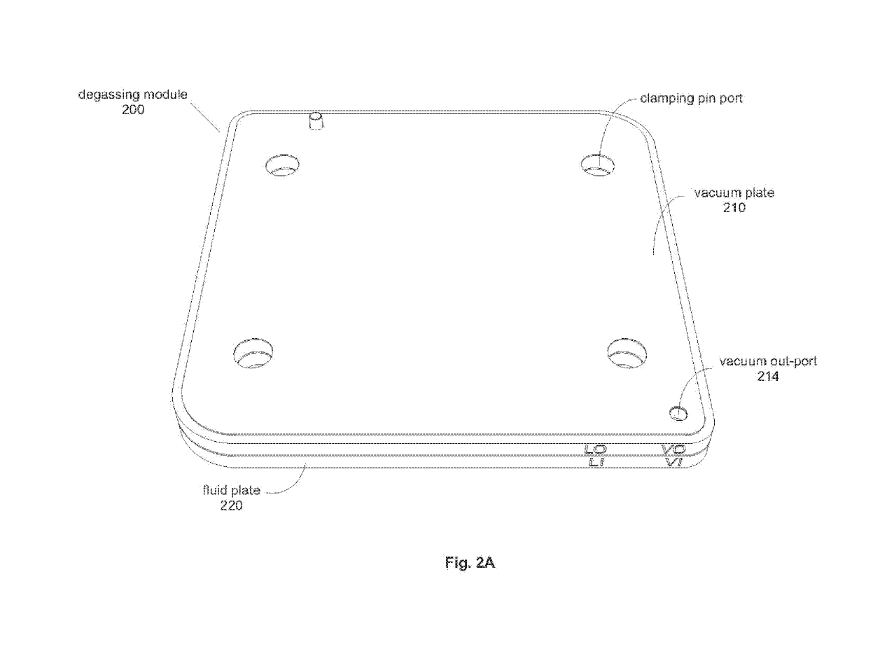

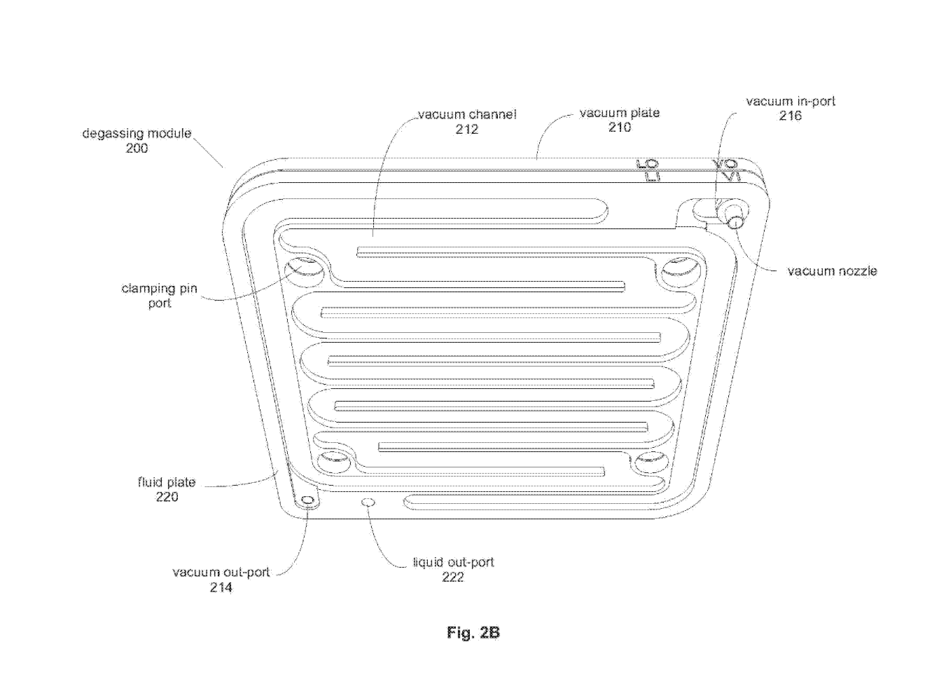

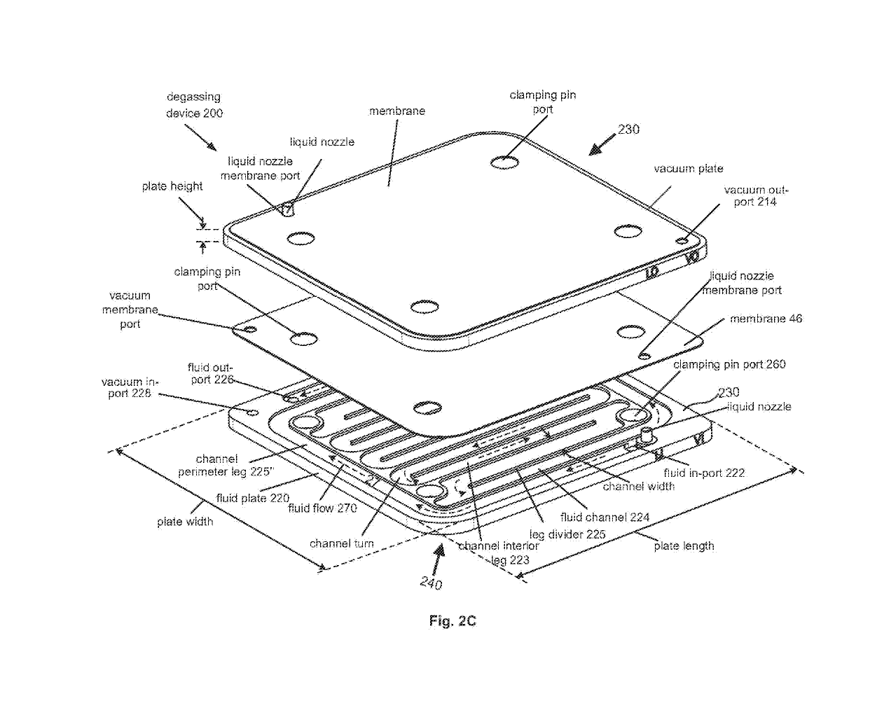

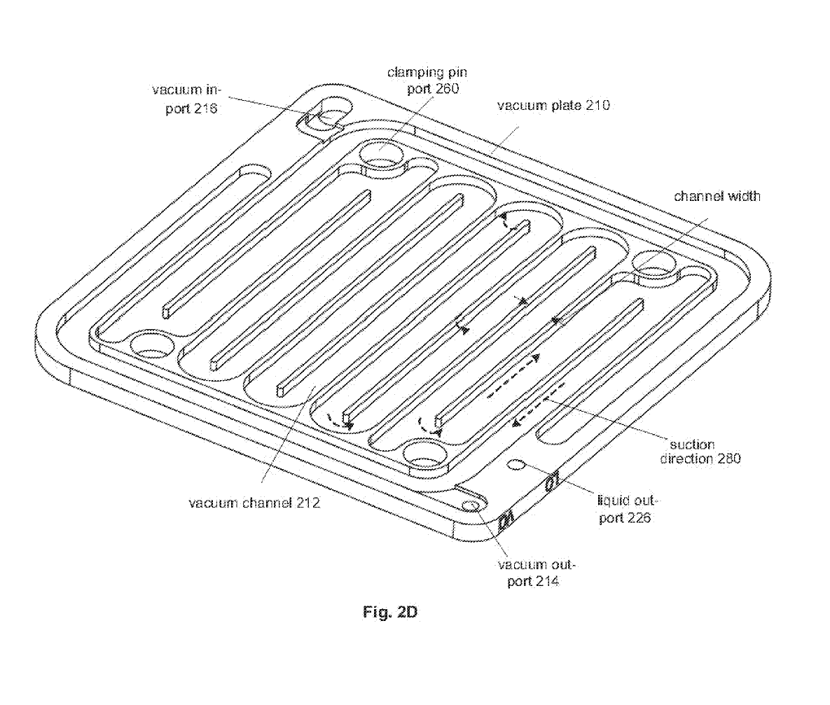

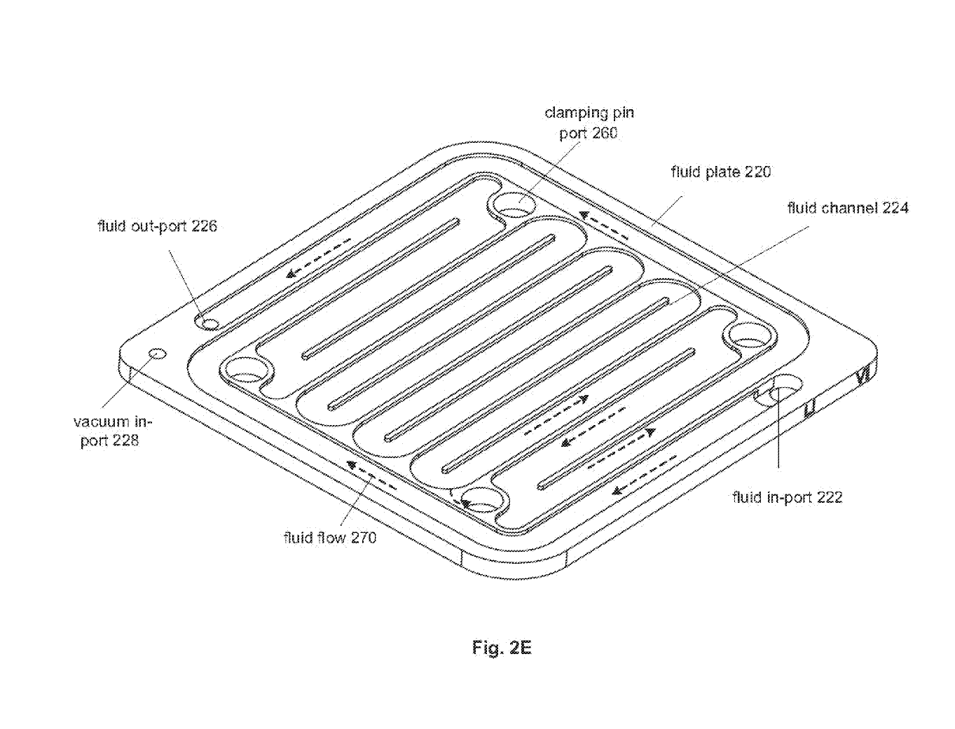

The modular degassing device 40 can have one or more membranes 46. The membranes 46 can separate fluid volumes 44 from gas volumes 48 in the modular degassing device 40. Fluids (i.e., the mixture of liquids and gasses) and/or degassed liquids can be contained and flow within the fluid volumes 44. Gasses (e.g., after extraction from the fluids) can be contained and flow within the gas volumes 48. The modular degassing device 40 can be made of one or more degassing modules, as shown in FIG. 2.

The fluid pump 30 and the fluid container 20 can be in fluid communication with the fluid volumes 44. The fluid pump 30 can be in fluid communication with the modular degassing device 40 through a liquid delivery channel 50. The fluid container 20 can be in fluid communication with the modular degassing device 40 through a fluid delivery channel 60.

The degassing system 10 can have a vacuum pump 70. The vacuum pump 70 can be in fluid communication with the gas volumes 48 of the modular degassing device 40, for example via a vacuum delivery channel 80.

The degassing system 10 can have a pressure regulator 90. The pressure regulator 90 can detect the pressure in the vacuum delivery channel 80 and/or the gas volume 48.

The pressure regulator 90 can be in data or power communication with the vacuum pump 70. The pressure regulator 90 can control (e.g., by sending data to a control element on the vacuum pump 70, directly reducing or increasing the electrical power delivered to the vacuum pump 70, or partially or completely opening a release valve) the vacuum pressure delivered by the vacuum pump 70, for example based upon the pressure detected in the vacuum delivery channel 80 and/or the gas volume 48.

The degassing system 10 can have a power supply 100. The power supply 100 can deliver and regulate power, such as electrical power, to the fluid pump 30, vacuum pump 70, pressure regulator 90, or combinations thereof The power supply 100 can have batteries and/or be connected to a wall electrical outlet.

The fluid pump 30 can create a negative pressure in the fluid container 20. The negative pressure in the fluid container 20 can cause the fluid in the fluid container 20 to flow, as shown by arrow, through the fluid delivery channel 60 and into the modular degassing device 40. The fluid can flow through the fluid volume 44 of the modular degassing device 40. The fluid can be in contact with the membrane 46.

The vacuum pump 70 can produce a vacuum in the vacuum delivery channel 80 and the gas volume 48. The vacuum can be regulated by the pressure regulator 90.

The modular degassing device 40 can remove some or all of the free and/or dissolved gasses from the liquid. The removed gasses can pass through the membrane 46 and into the gas volume 48. The removed gases can be withdrawn, as shown by arrow 85, from the modular degassing device 40.

The fluid can be completely or partially degassed. The completely or partially degassed fluid is referred to as a liquid. The liquid can flow, as shown by arrow 55, out of the modular degassing device 40 along the liquid delivery channel 50. The liquid flow rate can be from about 50 ml/min to about 600 ml/min, for example about 300 ml/min. The liquid can flow through the fluid pump 30 and to a destination, such as a laboratory analysis equipment such as a pipetting system, sealed storage reservoir, or combinations thereof

The degassed liquid can reach a residual gas concentration that can prevent the generation of harmful gas bubbles from bubble formation causes, such as temperature differences, pressure imbalances due to pump pressure differentials, changes in diameter and/or textures (e.g., roughness, ridges) of the interior of the liquid delivery channels, tubes, pipes, or lines.

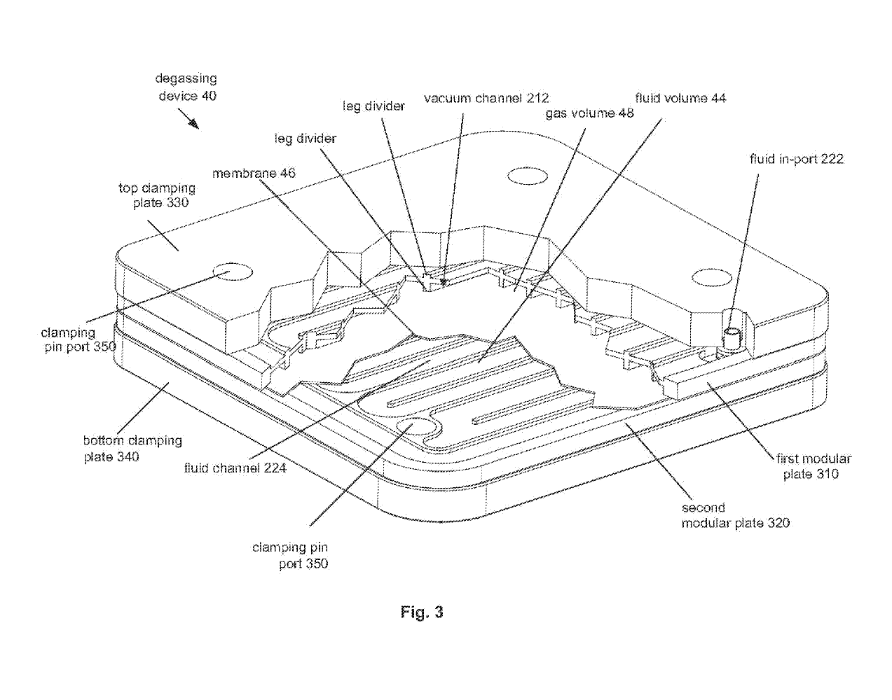

FIGS. 2A through 2E and 3 illustrate that a degassing module 200 of the modular degassing device 40 can have a vacuum plate 210, a membrane 46, a fluid plate 220, or combinations thereof. The top side 230 of the membrane 46 can be sealed to the vacuum plate 210. The bottom side 220 of the membrane 46 can be sealed to the fluid plate 220.

The membrane 46 can made from a flat panel of material, such as a polymer (e.g., polytetrafluoroethylene (PTFE), cellulose acetate, Nitrocellulose, cellulose esters, polysulfone, polyether sulfone, polyacrilonitrile, polyamide, polyimide, polyethylene, polypropylene, polyvinylidene fluoride (PVDF), polyvinylchloride (PVC), amorphous fluoropolymer (such as Teflon® AF from E.I. du Pont de Nemours and Co., of Wilmington, DE), polyester, polycarbonate, polyaramide), non-polymer (e.g., ceramic), or combinations thereof. The membrane 46 can be cut from a large-scale production piece of the material. The material of the membrane 46 can be inert to the fluids, for example to prevent contamination of degassed liquid.

The membrane 46 can have a membrane thickness from about 0.1 mm to about 1 mm, for example about 0.5 mm.

The vacuum plate 210, membrane 46, and fluid plate 220 can have the same plate width and plate length. The plate width can be equal (e.g., as a square) or unequal (e.g., as a rectangle) with the plate length. The plate width can be from about 80 mm to about 150 mm, for example about 135 mm. The plate length can be from about 80 mm to about 150 mm, for example about 135 mm. The vacuum plate 210 and the fluid plate 220 can have a plate height. The plate height of the vacuum plate 210 can be the equal to or unequal to the plate height of the fluid plate 220. The plate heights can be from about 4 mm to about 10 mm, for example about 5 mm.

The fluid plate 220 can have a fluid in-port 222. The fluid in-port 222 can be in fluid communication with the fluid delivery channel 60. The fluid plate 220 can have a fluid channel 224 extending and recessed within the fluid plate 220 from the fluid-in-port 222. The fluid plate 220 can have a fluid out-port 226. The fluid out-port 226 can be in fluid communication with the liquid delivery channel 50. The recessed fluid channel 224 can extend between the fluid in-port 222 and the fluid out-port 226.

The fluid plate 220 can have a vacuum in-port 228. The vacuum in-port 228 can be in fluid communication with the vacuum delivery channel 80. The vacuum plate 210 can have a vacuum channel 212. The vacuum channel 212 can be on the bottom side 240 of the vacuum plate 210 and can be similar in shape and size to the recessed fluid channel 224 (as seen in FIG. 3). The membrane 46 can have a vacuum membrane port 250. The vacuum membrane port 250 can be aligned with the vacuum in-port 228 and the vacuum channel 212, permitting the vacuum in-port 228 to be in fluid communication and deliver vacuum (e.g., remove gas removed from the fluid) to the vacuum channel 212. The vacuum plate 210 can have a vacuum out-port 214 in fluid communication with the vacuum delivery channel 80. The fluid channel 224 and the vacuum channel 212 form first channels of the degassing module 200.

Any or all of the ports can have nozzles extending through the ports. For example, the vacuum in-ports 228 and the vacuum out-ports 214 can have vacuum nozzles. The fluid in-port 226 and the fluid out-ports 226 can have liquid nozzles. The nozzles can extend between adjacent degassing modules 200. For example, the vacuum nozzle can extend from the vacuum in-port 228 on a first degassing module 200 into the vacuum out-port 214 on a second degassing module 200′ adjacent to the first degassing module 200.

The fluid channel 224 can be open or exposed on the top side 230 of the fluid plate 220, and covered by the membrane 46. The fluid channel 224 can have channel legs 223 divided by leg dividers 225. The leg dividers 225 can be rails, ridges, raised walls, or combinations thereof extending from the fluid plate 220 and/or from the membrane 46. For example, the membrane 46 can have integrated contours and can have the fluid channel 224 recessed within the membrane 46.

The channel legs 223 can include channel perimeter legs 223′ and channel interior legs 225″. The channel perimeter legs 225′ can extend from the fluid in-port 222, extend along the outer perimeter of the fluid plate 220, and extend to the fluid out-port 226. The channel interior legs 225′ can extend from the channel perimeter legs 225″. The channel interior legs 225″ can be parallel to each other. The channel interior legs 225″ can extend along more than 50% of the plate length, more narrowly more than 75% of the plate length, for example about 80% of the plate length. Each channel perimeter leg 225″ can be about the same ratio of the plate lengths as the channel interior legs 225′.

The fluid channel 224 can have a channel turn between each one of the adjacent channel leg 225′ or 225″. The channel turn can be from about 90° to about 180°, for example about 90° (e.g., as shown at the ends of channel perimeter legs 225″) also for example about 180° (e.g., as shown at the ends of adjacent channel interior legs 225′).

The fluid channel 224 can have a channel width. The channel width can be constant or variable along the length of the fluid channel 224. The channel width can be from about 4 mm to about 8 mm, for example about 8 mm. The fluid channel 224 can have a channel depth. The channel depth can be constant or variable along the length of the fluid channel 224. The channel depth can be from about 0.1 mm to about 1 mm, for example about 1 mm.

It will be appreciated that the channel depth and the degassing ratio correlate with each other. The smaller the channel depth the more amount of fluid in the fluid channel 224 has contact to the membrane 46. The more the fluid is in contact with the membrane 46, then the greater degree of degassing of the fluid.

The area of the fluid channel 224 in the plane of the surface of the fluid plate 220 can from about 6,000 mm² to about 20,000 mm², more specifically from about 8,000 mm² to about 15,000 mm², for example about 10,000 mm² The area of the fluid plate 220 can be from about 6,400 mm² to about 22,500 mm², for example about 18,225 mm². The area of the fluid channel 224 can be from about 36% to about 85% of the plate area, more specifically from about 44% to about 67% of the plate area, for example about 55% or more of the plate area.

The vacuum channel 212 can have the features and dimensions of the fluid channel 224 described above, but will be vertically symmetrical (e.g., on the bottom side 240 of the vacuum plate 210). The vacuum pump 70 can supply a vacuum to the vacuum delivery channel 80 and thus to the vacuum channel 212.

The vacuum plate 210, the membrane 46 and the fluid plate 220, or combinations thereof, can have aligned clamping pin ports 260. The clamping pin ports 260 can extend vertically through the fluid plate 220, the vacuum plate 210 and the membrane 46. The clamping pin ports 260 can receive clamping pins, such as bolds, rods, brads, anchors, or combinations thereof. The clamping pins can be used to clamp or compress the vacuum plate 210 and the fluid plate 220.

During use, the fluid can flow along the flow path of the fluid channel 224, as shown by dashed arrows 270 in FIGS. 2C and 2E. Negative pressure supplied by the fluid pump 70 draws the fluid. The fluid can enter the fluid channel 220 at the fluid in-port 222. The fluid can flow along the channel perimeter legs 225″ (on the near side of FIG. 2C), then through the channel interior legs 225′, then through the channel perimeter legs 225″ (on the far side of FIG. 2C), then out the fluid out-port 226.

As the fluid contacts the membrane 46, the vacuum from the vacuum channel 212 can draw free and dissolved gasses in the fluid out of the fluid, through the membrane 46, and into the vacuum channel 212. The gasses can be withdrawn from the vacuum channel 212 by the vacuum pump 70.

During use, the gases can be extracted out of the fluid, through the membrane 46, and flow along the flow path of the vacuum channel 212, as shown by the dashed arrows 280 in FIG. 2d. The gasses can be drawn by the negative pressure (i.e. vacuum) supplied by the vacuum pump 70. The suction and gasses from upstream degassing modules 200 can enter the vacuum channel 212 at the vacuum in-port 216. The gasses can flow along the vacuum channel 212 and then out the vacuum out-port 214.

The bottom side 240 (see FIG. 2C) of the fluid plate 220 can also have a vacuum channel. The top side 230 (see FIG. 2C) of the vacuum plate 210 can have a fluid channel. The vacuum channel 212 on the bottom side 240 of the fluid plate 220 and the fluid channel 224 on to top side 230 of the vacuum plate 210 form second channels of the degassing module 200. The vacuum channel in the fluid plate 220, and/or the fluid channel in the vacuum plate 210 can be utilized to degas fluid in conjunction with the next fluid plate or vacuum plate down or up, respectively, as more of the fluid plates 220 and the vacuum plates 210 are added to the degassing module 200. For example, an intermediate plate (not shown) may be positioned in between the fluid plate 220 and the vacuum plate 210 together with an additional one of the membrane 46, such that an individual one of the membrane 46 is positioned on both sides of the intermediate plate between the intermediate plate and either the fluid plate 220 or the vacuum plate 210, the intermediate plate having third channels, on one side one of the fluid channel 224 facing one of the vacuum channel 212, on the other side one of the vacuum channel 212 facing one of the fluid channel 224. In other words, the fluid plate 220 and/or the vacuum plates 210 can act as a fluid plate 220 on one side and a vacuum plate 210 on the opposite side. Each of these “dual-function” plates can have a fluid-carrying side and an opposite vacuum-carrying side, or the plate can have only a vacuum-carrying side or a liquid-carrying side, or a combination of plates can be used in a single one of the modular degassing device 40. The designations of the fluid plate 220 and the vacuum plate 210 used herein are for functional differentiation for illustrative purposes in reference to the respective figures. The fluid plate 220 and the vacuum plate 210 are also termed modular plates. For instance, the fluid plate 220 may be termed first modular plate 220, and the vacuum plate 210 may be termed second modular plate 210. The intermediate plate may be termed intermediate modular plate. The intermediate modular plate is of a type of the modular plates.

FIG. 3 illustrates that the modular degassing device 40 can have the degassing module 200 having a first modular plate 310, a membrane 46, and a second modular plate 320.

The first modular plate 310 and the second modular plate 320 can have the fluid channel 224 on one side of the plate and the vacuum channel 212 on the opposite side of the same plate. For example, the first modular plate 310 and the second modular plate 320 can be assembled so the vacuum channel 212 from the first modular plate 310 can face the fluid channel 224 from the second modular plate 212. In this case, the vacuum channel 212 on the first modular plate 310 and the fluid channel 224 on the second modular plate 212 form first channels of the degassing module 200 of the degassing device 40.

The first modular plate 310 can be identical to the second modular plate 320, and the first modular plate 310 can be turned upside down with respect to the second modular plate 320 before assembling the modular degassing device 40. The first modular plate 310 and the second modular plate 320 can be made from the same or identical molds, or machined from identical billets using the same machining protocol (e.g., the same code to drive a mill used to cut the fluid channels 224 and the vacuum channels 212).

The dividing walls extending into the gas volume 48 can have a dividing wall height equal to or larger than the dividing wall height of the dividing walls extending into the fluid volume 44. The vacuum pressure can pull the flexible membrane 46 slightly toward the gas volume 48. The volume of the gas volume 48 can be substantially equal to the volume of the fluid volume 46 during use.

The modular degassing device 40 can have a top one of outer clamping plates 330 on the top of the first modular plate 310. The modular degassing device 40 can have a bottom one of outer clamping plates 340 on the bottom of the second modular plate 320. The outer clamping plates 330 and 340 are positioned on two sides, at the top and the bottom, of the modular gassing device 40. Clamping pins (not shown) can be inserted through the clamping pin ports 350. The clamping pins can deliver a compressive force between the outer clamping plates 330 and 340, i.e. between the top one of the outer clamping plates 330 and the bottom one of the outer clamping plates 340. The compressive force seals the membrane 46.

The top one of the outer clamping plates 330 can be identical to the bottom one of the outer clamping plates 340. The top one of the outer clamping plates 330 can be turned upside down with respect to the bottom one of the outer clamping plates 340 before assembling the modular degassing device 40. The top one of the outer clamping plates 330 and the bottom one of the outer clamping plates 340 can be made from the same or identical molds, or machined from identical billets using the same machining protocol (e.g., the same code to drive an automated drill press used to cut the fluid clamping pin ports).

The modular degassing device 40 can be made from, for example, about four distinct parts, such as outer clamping plates (e.g., the top one of the outer clamping plates 330 and the bottom one of the outer clamping plates 340 can be identical in material, shape and size), modular plates (e.g., the first modular plates 310 and the second modular plates 320 can be identical in material, shape and size), clamping pins, membranes 46 (e.g., can all be cut from the same piece of membrane material), and connectors to and from the fluid in-ports 222, the vacuum in-ports 215, the fluid out-ports 226 and the vacuum out-ports 214.

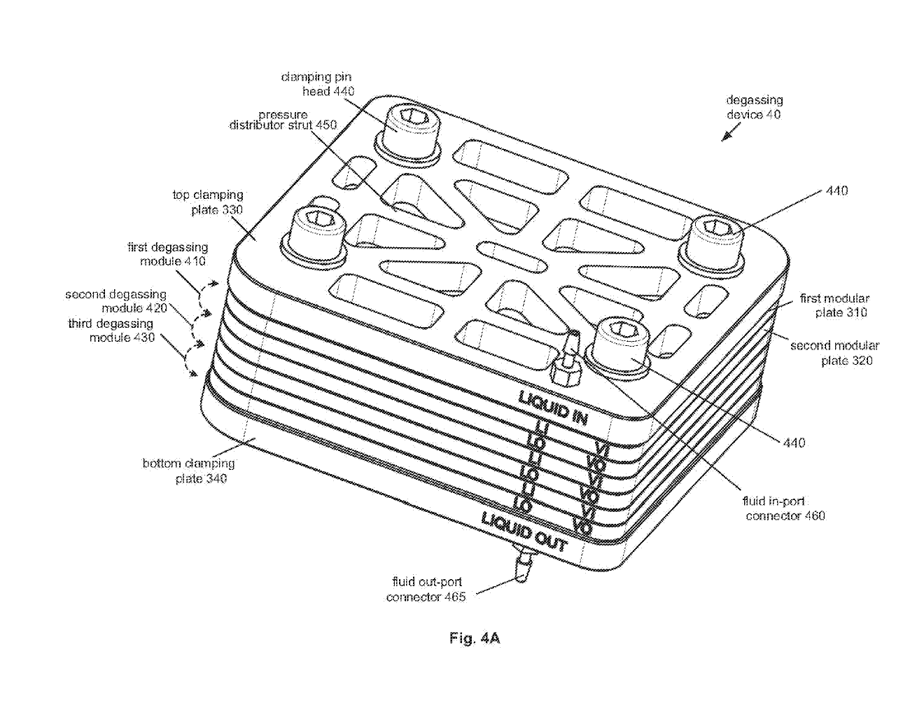

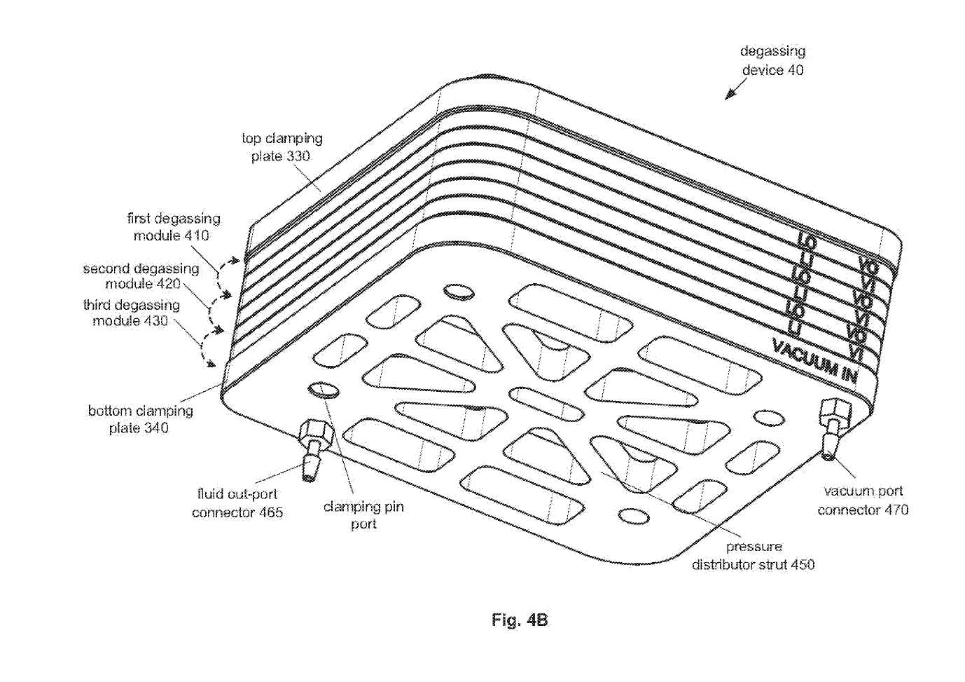

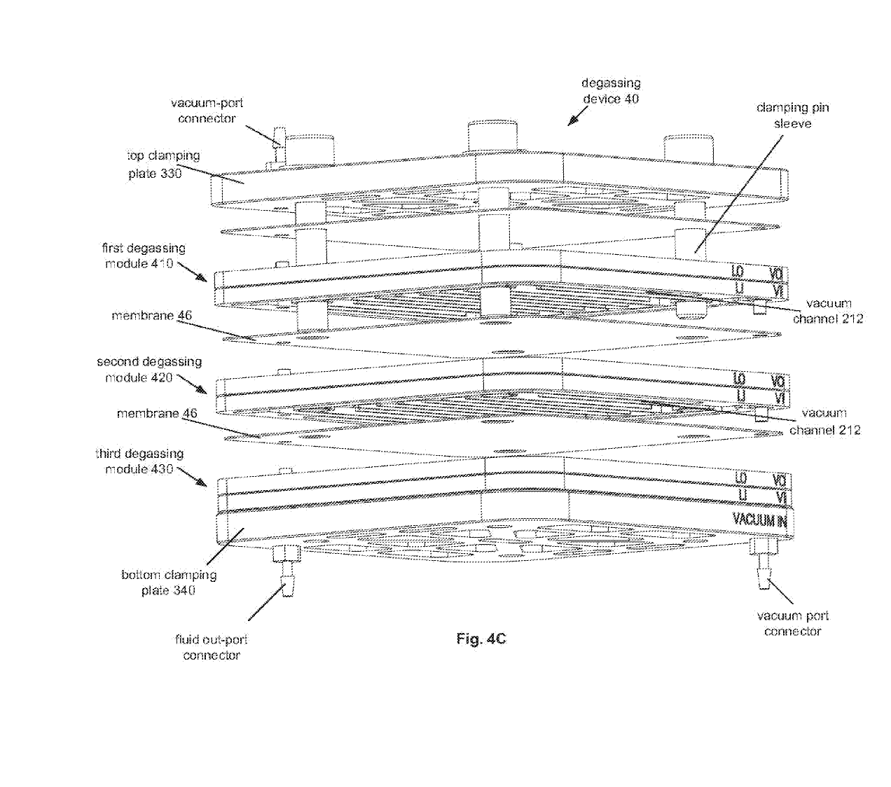

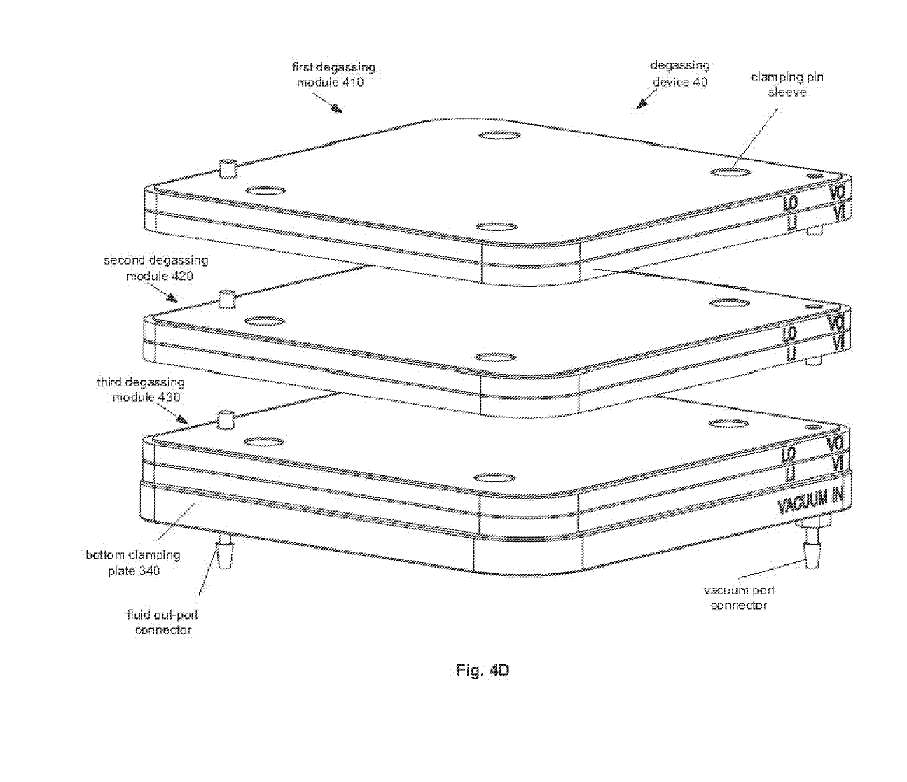

FIGS. 4A through 4d illustrate that the modular degassing device 40 can have a first degassing module 410 on a second degassing module 420 on a third degassing module 430. The modular degassing device 40 can be scaled up or down to have as many or few degassing modules 410, 420 430 as desired. The degassing modules 410, 420, 430 are identical to the degassing module 200, as shown in FIGS. 2A to 2d, and 3.

The membranes 46 can be positioned between the adjacent modular plates 310, 320 in adjacent degassing modules (e.g., the second modular plate 320 in the first degassing module 410 and the first modular plate 310 in the second degassing module 420). The volumes between the adjacent modular plates 310, 320 in adjacent degassing modules 410, 420, 430 can then become a fluid volume 44 and a vacuum volume 48, providing further flow of the fluid and vacuum for degassing.

For example, for each additional degassing module added to the modular degassing device 40, the flow rate of the modular degassing device 40 can increase by the ratio of two fluid volumes and two vacuum volumes to the existing number of fluid volumes and vacuum volumes. (e.g., If the modular degassing device 40 has one degassing module, e.g. 410, the modular degassing device 40 can have one operational fluid volume and one operational vacuum volume. Adding the second degassing module 420 can increase the total capacity of the modular degassing device 40 by two operational fluid volumes and two operational vacuum volumes. Therefore, the modular degassing device 40 can have three operational fluid volumes and three operational vacuum volumes. Accordingly, the modular degassing device can have a 200% increase in flow rate.).

For example, for each additional degassing module added to the modular degassing device 40, the total exterior size of the modular degassing device 40 can increase by equal to or less than the ratio of the new degassing module to the existing number of degassing modules (e.g., the modular degassing device 40 external size also can include the outer clamping plates).

Accordingly, scaling up the modular degassing device 40 by adding modules to the modular degassing device 40 can increase flow rate faster than the increase in size of the modular degassing device 40.

The clamping pins can each have one or two clamping pin heads 440 at one or both ends of the clamping pins. The clamping pin heads 440 can be radially larger that the clamping pins. The clamping pin heads 440 can include a tightening tooth interface, such as a hex head, and Allen wrench head, a flat or Philips screw head, or combinations thereof The clamping pins can have washers positioned between the clamping pin heads 440 and the outer clamping plates 330, 340. The clamping pins can be threaded. The clamping pin ports 350 can be threaded, for example, to threadably receive the clamping pins.

The outer clamping plates 330, 340 can have pressure distributor struts 450. The pressure distributor struts 450 can deliver high compressive clamping pressure to the outer clamping plates 330, 340 at the ends of the modules at the top and bottom ends of the modular degassing device 40.

The top one of the outer clamping plates 330 can have a fluid in-port connector 460. The fluid in-port connector 460 can place the fluid in-port 222 of the first degassing module 410 in fluid communication with the fluid delivery channel 60. The fluid in-port connector 460 can mechanically attach to the fluid delivery channel 60.

The bottom one of the outer clamping plates 340 can have a fluid out-port connector 465. The fluid out-port connector 465 can place the fluid out-port 226 of the third degassing module 430 in fluid (e.g., liquid) communication with the liquid delivery channel 50. The fluid out-port connector 465 can mechanically attach to the liquid delivery channel 50.

The bottom one of the outer clamping plates 340 can have a vacuum port connector 470. The vacuum port connector 470 can place the vacuum out-port 214 and/or the vacuum in-port 216 of the third degassing module 430 in fluid (e.g., gaseous) communication with the vacuum delivery channel 80. The vacuum port connector 470 can mechanically attach to the vacuum delivery channel 80.

The fluid flow from the input and output connectors (e.g., the fluid in-port connector 460, the fluid out-port connector 465, the vacuum port connector 470) can be in serial or parallel across the modules. For example, each module can have a separate fluid out-port connector 465 and a separate fluid in-port connector 460.

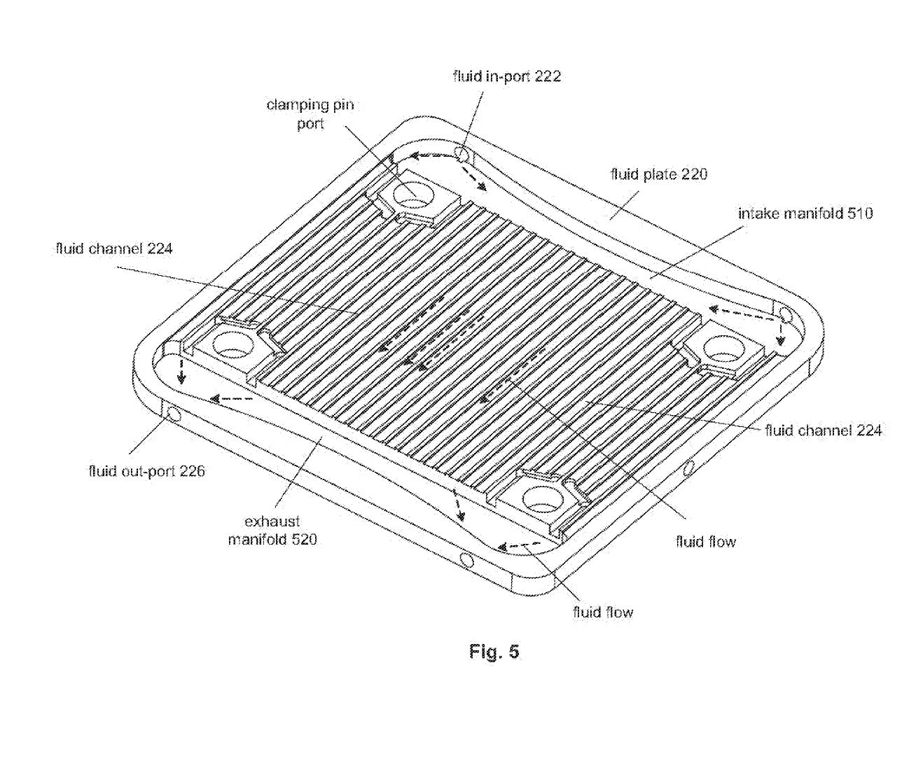

FIG. 5 illustrates that the fluid plate 220 can have one or more fluid in-ports 222 on a first lateral side of the fluid plate 220. The fluid in-ports 222 can open into an intake manifold 510. The intake manifold 510 can be in fluid communication with one or more parallel fluid channels 224. The fluid channels 224 can extend laterally across the fluid plate 220. The fluid channels 224 can open into an exhaust manifold 520. The exhaust manifold 520 can open to one or more fluid out-ports 226 on a second lateral side of the fluid plate 220 opposite to the first lateral side of the fluid plate 220. The fluid can flow from the fluid in-ports 222 into the intake manifold 510, then into and along the fluid channels 224, then into the exhaust manifold 520 and out of the fluid out ports 226. Each fluid channel 224 can have a separate fluid in-port 222 and/or a separate fluid out-port 226 (e.g., the fluid plate 220 can have no intake manifold 510 and/or exhaust manifold 520).

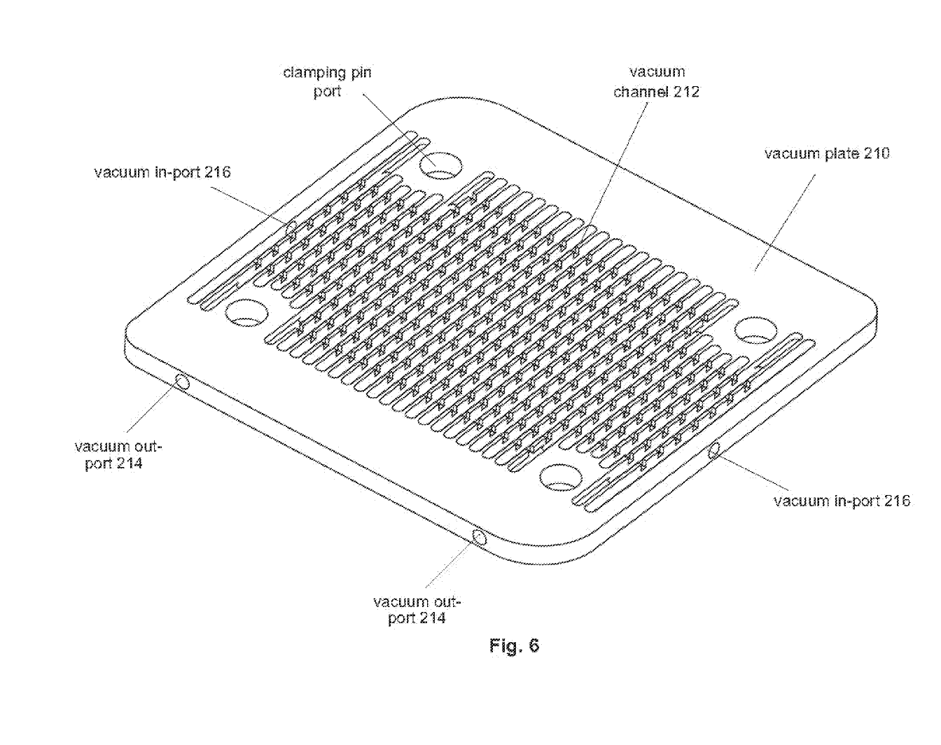

FIG. 6 illustrates that the vacuum plate 210 can have vacuum channels 212 that can extend laterally across the vacuum plate 210. The vacuum channels 212 can extend parallelly to each other. The vacuum plate 210 can have one or more vacuum out-ports 214 on the lateral sides of the vacuum plate 210. The vacuum plate 210 can have one or more vacuum in-ports 216 on the longitudinal sides of the vacuum plate 210.

The vacuum plate 210 of FIG. 6 can, for example, be used with a membrane 46 and the fluid plate 220 of FIG. 5. The fluid channels 224 of the fluid plate 220 in FIG. 5 and the vacuum channels 212 of the vacuum plate 212 in FIG. 1 form first channels of the degassing module 200 formed by assembling the vacuum plate 210, the fluid plate 220, and membrane 46. The vacuum plate 210 and the fluid plate 220 may also be termed modular plates.

The plates can be rigid. The plates can be made from plastic or metal, such as stainless steel.

The methods disclosed herein can be performed without delivering chemical additives to the fluids or using gas stripping. The methods disclosed herein can be performed at any temperature at which the fluid can flow, such as at room temperature for most fluids.

The devices and systems described herein can be used for any other methods described herein, including methods described in the background section herein and in combination with any devices or systems described herein, including those described in the background.

The membrane can have an integrated contour. For example, the fluid channels 224 can be formed onto the surface of one or both sides of the membrane 46. The fluid channels 224 in the membrane 46 can have the same shape, size, and characteristics of the fluid channels 224 disclosed herein for the fluid plates 220. The surface of the fluid plate 220 can still have the fluid channel 224 that can extend parallel with the fluid channel 224 in the membrane 46, or the surface of the fluid plate 224 can be flat, having no fluid channel.

The modular degassing device can have one or more hollow fibers. For example, each degassing module can have from about 50 hollow fibers to about 1200 hollow fibers, for example about 500 hollow fibers. The quantity of the fibers depends on the inner and outer diameter dimensions. The hollow fibers can have an inner diameter from about 0.08 mm to about 1 mm, for example about 0.2 mm. The hollow fibers can extend through the fluid channels. The modular degassing device can have the hollow fibers and/or the membranes. The hollow fibers can be made from the same materials disclosed herein for the membranes. The hollow fibers can be configured to fluid ports and/or the vacuum ports. For example, the modular degassing device can be configured so the fluid to be degassed flow through the lumens of the hollow fibers, or that the gasses flow through the hollow fibers.

Any elements described herein as singular can be pluralized (i.e., anything described as “one” can be more than one). Any species element of a genus element can have the characteristics or elements of any other species element of that genus. The above-described configurations, elements or complete assemblies and methods and their elements for carrying out the invention, and variations of aspects of the invention can be combined and modified with each other in any combination.

What is claimed is:

1. A modular degassing device, comprising outer clamping plates with at least one degassing module arranged therebetween, wherein the degassing module comprises two modular plates adjacently arranged, both modular plates having a first channel on sides facing a membrane placed therebetween, wherein the first channel of one modular plate is a fluid channel on one side of the membrane, and the first channel of the other modular plate is a vacuum channel on the other side of the membrane.

2. The modular degassing device according to claim 1, wherein any two degassing modules adjacently arranged both have a second channel on sides facing a membrane placed between the two degassing modules, wherein the second channel of one degassing unit is a fluid channel on one side of the membrane, and the second channel of the other degassing unit is a vacuum channel on the other side of the membrane.

3. The modular degassing device according to claim 1, wherein the two modular plates of any one of the at least one degassing unit have an intermediate modular plate arranged therebetween, the intermediate modular plate having on both sides a third channel facing a membrane placed between the intermediate plate and the respective one of the two modular plates, wherein one third channel is a fluid channel facing a vacuum channel of one of the two modular plates, and the other third channel is a vacuum channel facing a fluid channel of the other of the two modular plates.

4. The modular degassing device according to claim 1, wherein the membranes are gas permeable and hydrophobic.

5. The modular degassing device according to claim 1, wherein the fluid channels are fluidly connected in series or in parallel.

6. The modular degassing device according to claim 1, wherein the vacuum channels are fluidly connected in series or in parallel

7. The modular degassing device according to claim 1, further comprising clamping pins delivering a compressive force between the top clamping plate and the bottom clamping plate.

8. The modular degassing device according to claim 7, wherein the clamping pins are received in clamping pin ports.

9. The modular degassing device according to claim 1, wherein a fluid pump is fluidly connected to the fluid channels.

10. The modular degassing device according to claim 1, wherein a vacuum pump is fluidly connected to the vacuum channels.

11. The modular degassing device according to claim 1, wherein a pressure regulator is in data or power communication with the fluid pump and the vacuum pump.

12. A method for degassing a fluid comprising:
fluidly separating a plurality of fluid channels and a plurality of vacuum channels by means of a gas permeable and hydrophobic membranes;
drawing the fluid to flow along the plurality of fluid channels;
supplying a vacuum to the plurality of vacuum channels;
drawing gases from the fluid in the plurality of fluid channels through the membranes into the plurality of vacuum channels; and
withdrawing the gasses from the plurality of vacuum channels.

13. Use of a modular degassing device according to claim 1 for degassing a fluid.
